(19) United States
(12) Patent Application Publication
(10) Pub. No.: US 2012/0207076 A1
(43) Pub. Date: Aug. 16, 2012

(54) METHOD FOR TRANSMISSION OF CELL-SPECIFIC INFORMATION OF BASE STATION IN COORDINATED MULTI-POINT TRANSMISSION/RECEPTION SYSTEM

(75) Inventors: Sungjin Suh, Seoul (KR); Kyoungmin Park, Goyang-si (KR)

(73) Assignee: PANTECH CO., LTD., Seoul (KR)

(21) Appl. No.: 13/501,905

(22) PCT Filed: Oct. 12, 2010
(86) PCT No.: PCT/KR10/06984

§ 371 Date: Apr. 13, 2012

(30) Foreign Application Priority Data
Oct. 13, 2009 (KR) 10-2009-0097468
Oct. 14, 2009 (KR) 10-2009-0097932

(51) Int. Cl. H04W 4/06; H04W 72/04

(52) U.S. Cl. 370/312

(57) ABSTRACT

Disclosed is an apparatus and method for transmission of an uplink reference signal of a base station in a coordinated multi-point (multi-antenna) transmission/reception system and a coordinated multi-point transmission/reception method of a User Equipment (UE). Frequency, time, or code resources are divided in order to decrease the occurrence of interference between adjacent cells in transmission of an uplink reference signal in a coordinated multi-point transmission/reception system.

### CROSS-REFERENCE TO RELATED APPLICATIONS

This application is the National Stage Entry of International Application No. PCT/KR2010/006984, filed on Oct. 12, 2010, and claims priority from and the benefit of Korean Patent Application Nos. 10-2009-0097468, filed on Oct. 13, 2009, and 10-2009-0097932, filed on Oct. 14, 2009, all of which are herein incorporated by reference for all purposes as if fully set forth herein.

### BACKGROUND

1. Field

Exemplary embodiments of the present invention relate to a method for transmission of an uplink reference signal of a base station in a coordinated multi-point (multi-antenna) transmission/reception system and a coordinated multi-point transmission/reception method of a User Equipment (UE).

2. Discussion of the Background

With the development of communication systems, a wide variety of wireless terminals are being used by consumers, such as businesses and individuals.

Therefore, the communication service providers are attempting to create a new communication service market for the wireless terminals and enlarge the existing communication service market by providing reliable and low-priced services.

### SUMMARY

Additional features of the invention will be set forth in the description which follows, and in part will be apparent from the description, or may be learned by practice of the invention.

An exemplary embodiment of the present invention discloses a method for transmitting an uplink reference signal in a mobile communication system, the method including: grouping a plurality of User Equipments (UEs) within a serving cell into a UE group using a coordinated multi-point transmission/reception service and a UE group using a general service; and transmitting first parameters established for the UE group using a coordinated multi-point transmission/reception service and transmitting second parameters established for the UE group using a general service to the plurality of UEs within the serving cell.

An exemplary embodiment of the present invention discloses a method for transmitting and receiving a signal in a coordinated multi-point transmission/reception system, the method including: transmitting N parameter sets related to an uplink reference signal by a Base Station (BS); receiving the N parameter sets by a User Equipment (UE); and selecting a parameter set corresponding to the UE from among the N parameter sets by the UE.

An exemplary embodiment of the present invention discloses a method for transmitting an uplink reference signal by a User Equipment (UE) in a mobile communication system, the method including: receiving first parameters established for a UE group using a coordinated multi-point transmission/reception service and second parameters established for a UE group using a general service; and identifying the received first parameters and second parameters, and selecting a UE group by which the uplink reference signal is to be transmitted based on the received first parameters and second parameters.

An exemplary embodiment of the present invention discloses a base station to transmit an uplink reference signal in a mobile communication system, the base station including: a grouper to group a plurality of User Equipments (UEs) within a base station into a UE group using a coordinated multi-point transmission/reception service and a UE group using a general service; and a transmitter to transmit first parameters established for the UE group using a coordinated multi-point transmission/reception service and second parameters established for the UE group using a general service to the plurality of UEs within the base station.

An exemplary embodiment of the present invention discloses a terminal to transmit an uplink reference signal in a mobile communication system, the terminal including: a receiver to receive first parameters established for a UE group using a coordinated multi-point transmission/reception service and second parameters established for a UE group using a general service; and an identifier to identify the received first parameters and second parameters and to select a UE group by which the uplink reference signal is to be transmitted based on the received first parameters and second parameters.

An exemplary embodiment of the present invention discloses a mobile communication system to transmit and to receive a signal in a coordinated multi-point transmission/reception system, the system including: a base station to transmit N parameter sets related to an uplink reference; and a terminal to receive the N parameter sets and to select a parameter set corresponding to the terminal from among the N parameter sets.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block diagram illustrating a wireless communication system according to an exemplary embodiment of the present invention.

FIG. 2 illustrates a coordinated multi-point transmission/reception system according to an exemplary embodiment of the present invention.

FIG. 3 illustrates a structure of subframes including an uplink reference signal in a wireless communication system according to an exemplary embodiment of the present invention.

FIG. 4 shows graphs illustrating a time division scheme according to an exemplary embodiment of the present invention.

FIG. 5 illustrates a system construction for SRS transmission in a coordinated multi-point transmission/reception system.

FIG. 6 illustrates a system construction for transmitting an uplink reference signal (e.g. SRS) using broadcast information in a coordinated multi-point transmission/reception system.

FIG. 7 is a flowchart of a method for transmitting a signal by using broadcast information in a coordinated multi-point transmission/reception system according to an exemplary embodiment of the present invention.

FIG. 8 illustrates an example of a parameter group-based broadcast information list managed by each cell according to an exemplary embodiment of the present invention.

FIG. 9 is a block diagram illustrating a base station and a terminal an uplink reference signal in a mobile communication system according to an exemplary embodiment of the present invention.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. Various changes, modifications, and equivalents of the systems, apparatuses, and/or methods described herein will likely suggest themselves to those of ordinary skill in the art. Like elements, features, and structures are denoted by the same reference numerals throughout the drawings and the detailed description, and the size and proportions of some elements may be exaggerated in the drawings for clarity and convenience.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is connected, coupled or joined to another component, a third component may be connected, coupled, and joined between the first and second components, although the first component may be directly connected, coupled or joined to the second component.

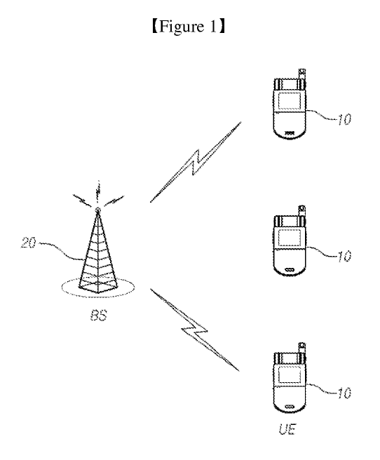

FIG. 1 is a block diagram illustrating a wireless communication system according to an exemplary embodiment of the present invention.

The wireless communication system is widely arranged in order to provide various communication services, such as voice, packet data, etc.

Referring to FIG. 1, a wireless communication system includes a UE (User Equipment) 10 and a BS (Base Station) 20. The UE 10 and the BS 20 use various resource allocation schemes as described below.

As used herein, the UE 10 has an inclusive meaning referring to a user terminal for wireless communication, and should be construed as including not only a UE in WCDMA (Wideband Code Division Multiple Access), CDMA (Wideband Code Division Multiple Access), LTE (Long Term Evolution), HSPA (High Speed Packet Access), etc., but also a UT (User Terminal), SS (Subscriber Station), and wireless device and an MS (Mobile Station) in GSM (Global System for Mobile Communication).

The BS 20 may be a cell and generally refers to a fixed station communicating with the UE 10, and may be described as another name, such as Node-B, eNB (evolved Node-B), BTS (Base Transceiver System), or AP (Access Point). That is, as used herein, the BS 20 or cell should be construed as having an inclusive meaning indicating an area controlled by a BSC (Base Station Controller) of the CDMA (Code Division Multiple Access), a Node B or a Radio Network Controller (RNC) of the WCDMA, etc., and may correspond to one of various coverage areas, which include a mega cell, a macro cell, a micro cell, a pico cell, femto cell, etc.

The UE 10 and the BS 20 are not limited to specifically expressed terms or words and inclusively indicate two transmitting and receiving agents used for implementation of the technology or technical idea described herein.

There is no limit in the multiple access schemes applicable to a wireless communication system. That is, various multiple access schemes, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, and OFDM-CDMA, may be applied to the wireless communication system according to aspects of the present invention.

For uplink transmission and downlink transmission, it is possible to use either a TDD (Time Division Duplex) scheme using different times for transmission or an FDD (Frequency Division Duplex) scheme using different frequencies for transmission according to aspects of the present invention.

Resource allocation according to exemplary embodiments of the present invention may be applied to resource allocation in the asynchronous wireless communication, which is evolving to LTE (Long Term Evolution) and LTE-A (LTE-advanced) through GSM, WCDMA, and HSPA, and resource allocation in the synchronous wireless communication, which is evolving to CDMA, CDMA-2000, and UMB. Aspects of the present invention shall not be restrictively construed based on a particular wireless communication field and shall be construed to include all technical fields to which the aspects of the present invention may be applied.

In the current beyond 3 G communication technology in discussion, a UE delivers uplink channel information to a BS by transmitting a reference signal similar to the pilot signal of a conventional 2G system in the uplink. This reference signal may be selected to reflect various operation modes, such as a period, a frequency bandwidth, a start point, and a hopping pattern, which may be determined based on cell-specific parameters or UE-specific parameters. The cell-specific parameters refer to parameters by which it is possible to determine between BSs, and the UE-specific parameters refer to parameters by which it is possible to determine between UEs.

The frequency bandwidth, period, and subframe configuration of an uplink reference signal, which are being discussed in the current LTE, are determined by the cell-specific parameters. All UEs belonging to a cell receive the same cell-specific parameter and operate in a mode determined according to the cell-specific parameter.

Further, the current beyond 3 G communication technology in discussion includes a coordinated multi-point (CoMP) transmission/reception system or a coordinated multi-antenna transmission system. In a coordinated multi-point transmission/reception system, when multiple BSs try to provide a coordinated transmission/reception service for one user, they allocate the same frequency resource to the same time for the service.

In the coordinated multi-point transmission/reception system as described above, the same frequency resource is allocated to the same time in transmission/reception of coordinated data between a BS and a UE. That is, in the same time interval, multiple BSs, which have been selected as coordinated BSs, transmit or receive data to or from one user by using the same frequency resource.

The UEs using such a communication scheme may be UEs located in a boundary area between cells, which have a signal intensity weaker than that of UEs located in central areas of cells. Further, the UEs may be UEs located relatively near another BS so that they can receive signals from multiple BSs. When multiple BSs transmit signals to such UEs in a coordinated way, it is possible to obtain a better performance than the conventional way in which a UE receives signals from a single BS.

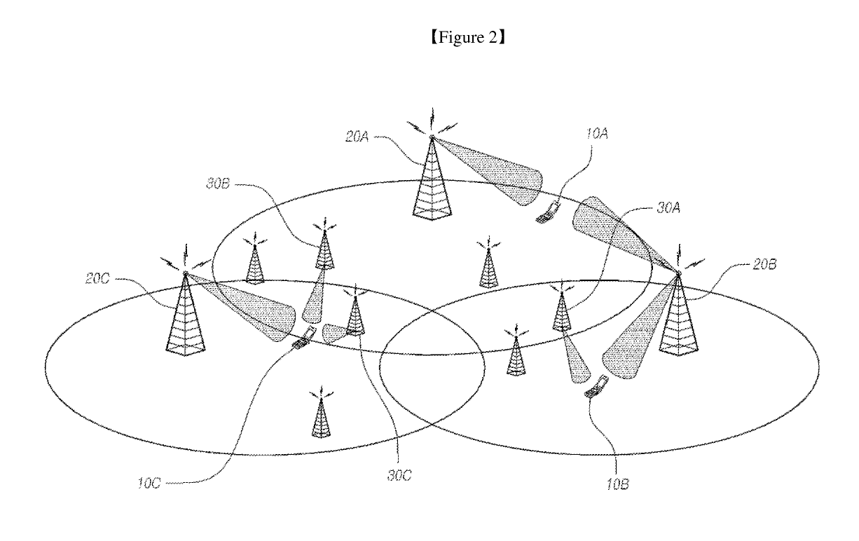

FIG. 2 illustrates a coordinated multi-point transmission/reception system according to aspects of the present invention.

In the coordinated multi-point transmission/reception system as shown in FIG. 2, which is more advanced than the conventional technology in which a UE is connected to and receives signals from a single BS, a UE can transmit and receive data to and from more than one BS, so as to achieve a higher data efficiency and receive a service of a better quality.

Referring to FIG. 2, a first UE 10A can connect with and receive services from two or more BSs 20A and 20B. Further, within a period, the first UE 10A may connect with and receive a service from a BS having the best channel condition among the BSs 20A and 20B.

The wireless communication system may have a relay or relay node 30A or 30B between the UE 10 and the BS 20. The relay 30A or 30B may have its own physical cell Identifier (ID), can transmit its synchronization channels and reference symbols or reference signals, and may not generate any new cell without a separated cell ID.

Further, a second UE 10B can simultaneously connect with one BS 20B and one relay 30A and can receive a service from the BS 20B. Moreover, a third UE 10C can simultaneously connect with one BS 20C and two or more relays 30B and 30C and can receive a service from the BS 20C. The third UE 10C may simultaneously connect with one BS 20C and two or more relays 30A and 30B and can receive a service from the BS 20C. As used herein, the coordinated relays 30A and 30B are considered as a kind of coordinated BS.

The first UE 10A, the second UE 10B, and the third UE 10C and the BSs 20A, 20B, and 20C shown in FIG. 2 correspond to the UE 10 and the BS 20 shown in FIG. 1. Therefore, in the following description, a UE may be indicated by 10A, 10B, or 10C if a determination between UEs is necessary and is indicated by 10 if a determination between UEs is unnecessary. By the same reason, a BS is indicated by 20 if a determination between BSs is unnecessary. Also, by the same reason, a relay is indicated by 30 if a determination between relays is unnecessary.

While a beam formation or precoding value is set in consideration of the channel state of only the serving BS, from which a UE currently receives a service, in the conventional system, a beam formation or precoding value is set in consideration of estimation values or interference values for the channel state of neighbor BSs in the coordinated multi-point transmission/reception system.

In the coordinated multi-point transmission/reception system, for transmission/reception of coordinated data between the BS 20 and the UE 10, a same frequency resource is allocated to the same time interval. That is, in the same time interval, multiple BSs 20A and 20B selected as coordinated BSs transmit or receive data to or from one UE 10A by using the same frequency resource. The selected coordinated BSs may be selected according to a quality of channel performance for a frequency band for a UE.

The UE 10 can identify the channel state of each antenna of each BS 20 by analyzing a reference signal transmitted from each BS 20. After identifying the channel state of each antenna, the UE 10 directly or indirectly feeds back the information to each BS 20. Upon receiving the fed back information, the BS 20 or a higher layer generates a coordinated BS set by selecting BSs (for example, BSs 20A and 20B of FIG. 2), and the BSs included in the coordinated BS set starts a coordinated data transmission/reception. The BSs selected may be selected according to a quality of channel performance.

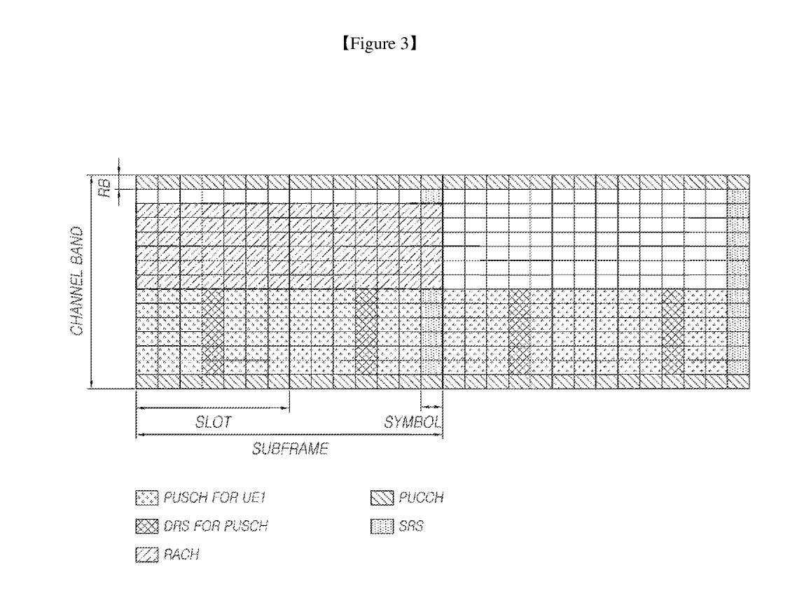

FIG. 3 illustrates a structure of subframes including an uplink reference signal in a wireless communication system. Referring to FIG. 3, reference signals allocated to subframes may include a DRS (Demodulation Reference Signal) and an SRS (Sounding Reference Signal). The SRS refers to an uplink reference signal used when a UE delivers uplink channel information to a BS.

The SRS delivers uplink channel information of the entire bands including not only a band to be used by each UE but also a band, which the UE may use, to the BS. That is, the UE transmits the SRS over all the subcarrier bands.

As shown in FIG. 3, the SRS may be transmitted once at each subframe, and may be transmitted once or k times at every N subframes. A frequent transmission of the SRS may be used in an environment in which the channel state changes as rapidly as the frequency with which the channel state information should be obtained by the UE 10 is increased. In contrast, a rare transmission of the SRS may be used in an environment in which the channel state does not rapidly change and a frequent obtainment of the SRS is unnecessary.

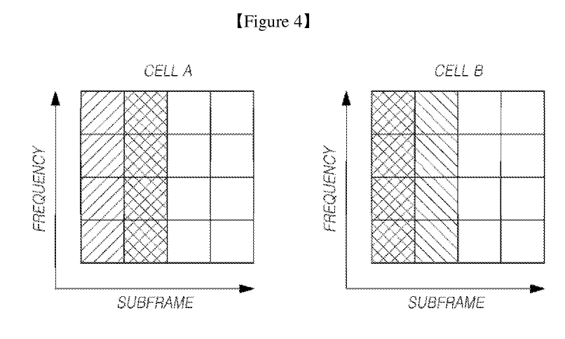

FIG. 4 shows graphs illustrating a time division scheme, which can decrease transmission of SRSs in a same subframe between two adjacent cells. Referring to FIG. 4, the SRS is time-divided for the neighbor cells, and cell B does not transmit any signal at all at the subframe position at which cell A transmits a signal while cell A does not transmit any signal at all at the subframe position at which cell B transmits a signal, so that there is no interference between the two cells.

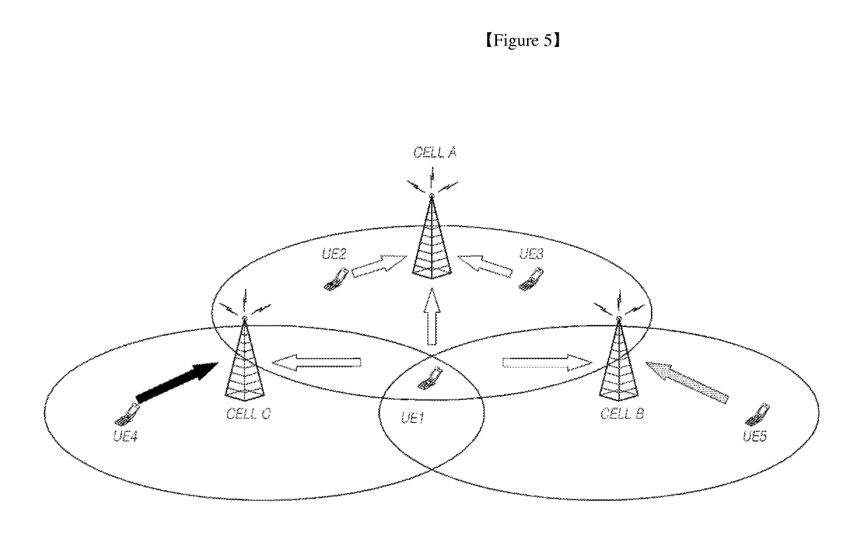

UE 1 to UE 5 and cells A, B, and C shown in FIG. 5 correspond to the UEs 10A, 10B, and 10C and the BSs 20A, 20B, and 20C, respectively.

Schemes for SRS transmission between neighbor cells without interference include a frequency division scheme and a code division scheme as well as the time division scheme described above.

In the frequency division scheme, different frequency resources for transmission of reference signals are allocated between neighbor cells, so as to decrease the use of the same frequency resource by the neighbor cells while allowing the transmission of reference signals through the entire bands by each UE. In the code division scheme, reference signals of neighbor cells are identified by codes, so as to decrease interference between the neighbor cells.

FIG. 5 illustrates a system construction for SRS transmission in a coordinated multi-point transmission/reception system. UE 1 to UE 5 and cells A to C shown in FIG. 5 correspond to the UEs 10A, 10B, and 10C and the BSs 20A, 20B, and 20C, respectively.

Referring to FIG. 5, on an assumption that a serving cell (a cell, from which UE 1 receives a control signal, from among the coordinated three cells) of UE 1 is cell A, UE 1 receives a cell-specific parameter from cell A and transmits an uplink reference signal (e.g. SRS). Moreover, since all UEs belonging to cell A, which include UE 2 and UE 3, receive the same cell-specific parameters, UE 2 and UE 3 also transmit uplink reference signals based on the same cell-specific information.

At this time, cell B and cell C can send cell-specific information properly set for normal characteristics of UEs currently belonging to the cells. If necessary, cell B and cell C can forward cell-specific information, which can decrease performance degradation of the UEs currently belonging to the cells within a range capable of decreasing overlapping of time, frequency, or code resources with those of cell A.

However, cell A has a considerable restriction in setting its cell-specific information, because the cell-specific information of cell A is required to reduce interference with a neighbor cell, that is, to decrease the overlapping of resources with those of a neighbor cell, due to UE 1 to which the coordinated multi-antenna transmission/reception technique is applied. Such a restriction may cause performance degradation of other UEs (i.e. UE 2 and UE 3) which do not receive the coordinated multi-antenna transmission/reception service. This is because, without UE 1, UE 2 and UE 3 can receive cell-specific information, which does not have the restriction as described above, and can transmit an uplink reference signal based on the received cell-specific information.

As a simple example, in order to decrease resource overlapping between adjacent cells for UEs receiving a coordinated multi-antenna transmission/reception service, if UEs of cell A have been set to be capable of transmitting an uplink reference signal in the first subframe from among five subframes, all UEs (UE 1, UE 2, and UE 3) of cell A can only transmit the uplink reference signal once at every five subframes. However, the UEs (UE 4 and UE 5) of cell B and cell C can allocate an uplink reference signal to the second and third or third and fourth subframes from among the five subframes. Then, the UEs (UE 4 and UE 5) of cell B and cell C can transmit the uplink reference signal twice as frequently as the UEs (UE 1, UE 2, and UE 3) of cell A, which decreases performance. This example may also be applied to the case of frequency division or code division.

In summary, the uplink reference signal according to the related art does not take into consideration the interference between adjacent cells. However, with the introduction of the coordinated multi-antenna transmission/reception system has made it necessary for one UE to simultaneously transmit the same reference signal to adjacent cells, which may cause interference between cells. According to aspects of the present invention, a method of dividing time, frequency, or code resources between adjacent cells may be employed to decrease interference between cells of the coordinated multi-antenna transmission/reception system.

The enhanced reference signal transmission scheme as described above may be advantageous for a UE, to which the coordinated multi-antenna transmission/reception is applied, but may cause a performance degradation of the other UEs within the same cell. According to aspects of the present invention, information related to the uplink reference signal may be arranged in a determined way between the UEs, to which the coordinated multi-antenna transmission/reception is applied, and the other UEs, and the arranged information may be broadcasted so that the UEs can reduce the interference by using the broadcasted information.

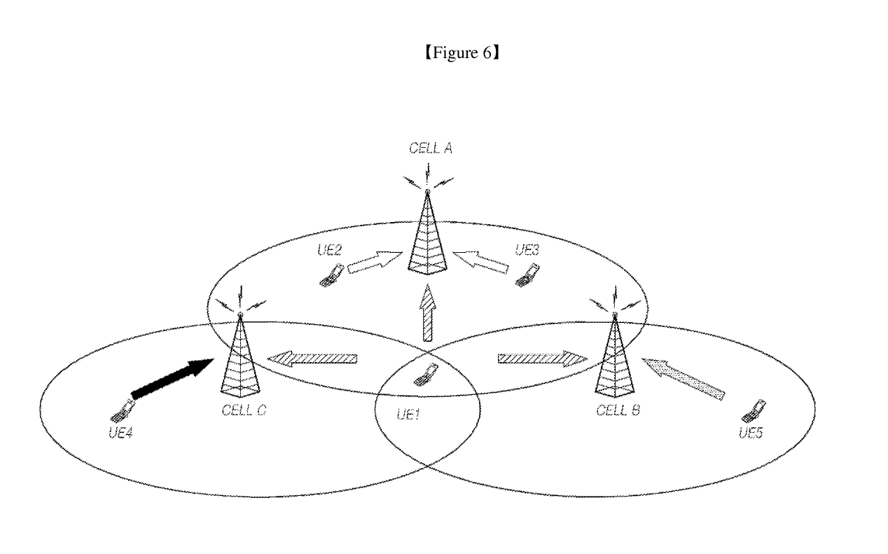

FIG. 6 illustrates a system construction for transmitting an uplink reference signal (e.g. SRS) using broadcast information in a coordinated multi-point transmission/reception system according to aspects of the present invention. UE 1 to UE 5 and cells A to C shown in FIG. 6 correspond to the UEs 10A, 10B, and 10C, and the BSs 20A, 20B, and 20C, respectively.

In the coordinated multi-point transmission/reception system shown in FIG. 6, in a particular cell (e.g. cell A), information related to the uplink reference signal is arranged in a determined way between the UE (UE 1), to which the coordinated multi-antenna transmission/reception is applied, and the other UEs (UE 2 and UE 3), and the arranged information is broadcasted to the UEs. Each of the UEs receive the broadcasted information related to the uplink reference signal, and transmits an uplink reference signal (e.g. SRS) reflecting information related to itself to cell A, cell B, and cell C.

As a result, although the UE (UE 1), to which the coordinated multi-antenna transmission/reception is applied, and the other UEs (UE 2 and UE 3) belong to the same cell, each UE can transmit uplink reference signals to the cells (e.g. cell A, cell B, and cell C), to which they belong, with at least one type of different resources from among the time, frequency, and code resources. Of course, it is possible for the UE (UE 1), to which the coordinated multi-antenna transmission/reception is applied, and the other UEs (UE 2 and UE 3), to transmit uplink reference signals to cell A with the same time, frequency, and code resources.

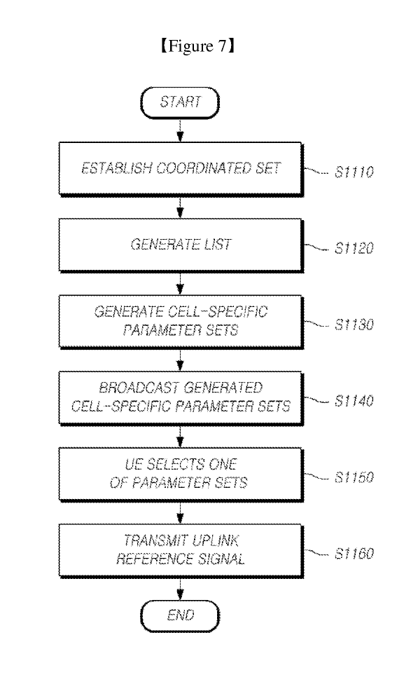

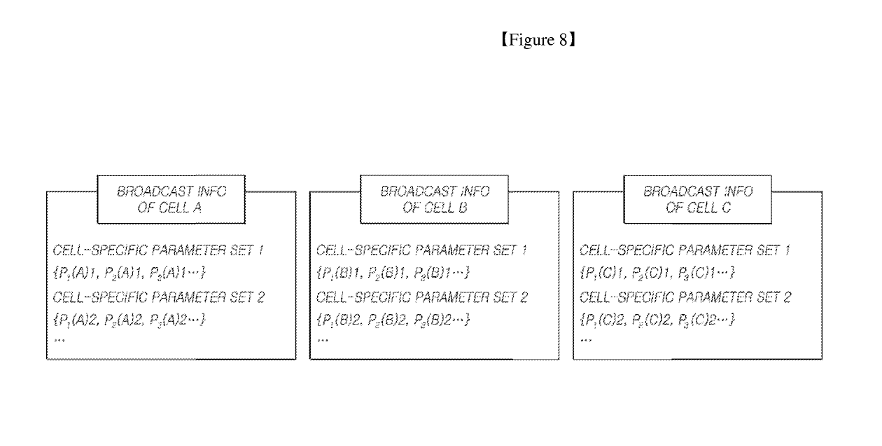

FIG. 7 is a flowchart of a method for transmitting a signal by using broadcast information in a coordinated multi-point transmission/reception system according to an exemplary embodiment of the present invention, and FIG. 8 illustrates an example of a parameter group-based broadcast information list managed by each cell according to an exemplary embodiment of the present invention.

Referring to FIG. 6, FIG. 7, and FIG. 8, a particular BS or cell transmits a signal using broadcast information, for example, an uplink reference signal, according to a transmission method in a coordinated multi-point transmission/reception system according to an exemplary embodiment of the present invention.

First, a particular serving cell of UE 1 to UE 3 (for example, cell A) establishes cell A, cell B, and cell C as a coordinated cell set in order to support a coordinated multi-point transmission/reception service for a coordinated UE, e.g. UE 1 (operation S1110).

Then, cell A generates a list in which UE 1 is separated from the other UEs as a user receiving the coordinated multi-point transmission/reception service (operation S1120).

Next, as shown in FIG. 8, cell A exchanges information with neighbor cells, and establishes cell-specific parameter set 1 for a user group receiving a coordinated multi-point transmission/reception service and cell-specific parameter set 2 for general users, so that they can send uplink reference signals without resource overlapping (operation S1130). Although FIG. 8 shows the case including two cell-specific parameter sets 1 and 2, there may be N cell-specific parameter sets 1 to N. The cell-specific parameters included in the cell-specific parameter set 1 and 2 may include a frequency bandwidth, period, or subframe configuration of an uplink reference signal.

Further, referring to FIG. 8, cell-specific parameter set N refers to a cell-specific parameter set for a particular group (group N) from among the cell-specific parameter sets transmitted to users (UEs) of corresponding cells. In PM(K)N, M indicates the order of the parameter, K indicates cell information, and N indicates a group number of the cell-specific parameter set. That is, PM(K)N refers to the Mth parameter of the Nth cell-specific parameter set of cell K.

Next, as shown in FIG. 7, the newly established parameter sets are transmitted to all UEs within a corresponding cell (e.g. cell A) through a broadcast channel or a data channel (operation S1140). That is, cell A transmits grouped parameter sets in order to transmit an uplink reference signal through broadcast information to all UEs within the cell.

Thereafter, a UE having received the cell-specific information from cell A determines if the UE itself corresponds to a general UE or a UE using the coordinated multi-point transmission/reception service, and then selects corresponding cell-specific parameter set N (operation S1150). For example, a UE using the coordinated multi-point transmission/reception service, that is, UE 1 of FIG. 6, selects cell-specific parameter set 1 of FIG. 8, while general UEs, that is, UE 2 and UE 3 of FIG. 6, select cell-specific parameter set 2 of FIG. 8.

In order for each UE to determine if it corresponds to a general UE or a UE using the coordinated multi-point transmission/reception service, an indicator transmitted from a corresponding cell may be necessary. Since each cell can determine between a UE using the coordinated multi-point transmission/reception service and a general UE as in operation S1120, each cell can transmit information about if a UE corresponds to a general UE or a UE using the coordinated multi-point transmission/reception service according to the indicator. Each cell can transmit this indicator to the UE either before or after transmission of the cell-specific parameter set.

Thereafter, each UE transmits an uplink reference signal according to a corresponding cell-specific parameter set (operation S1160). For example, UEs (UE 1, UE 2 and UE 3) belonging to cell A allocate uplink reference signals to the first and second subframes of every five subframes and transmit them to cell A, and UEs (UE 4 and UE 5) respectively belonging to cell B and cell C allocate uplink reference signals to the second and third subframes or the third and fourth subframes of every five subframes and transmit them to cell B and cell C. Then, when UE 1 belonging to cell A becomes a UE receiving a coordinated multi-point transmission/reception service, UE 1 transmits an uplink reference signal (e.g., an SRS) through only the first subframe of every five subframes to cells A, B, and C in order to decrease the occurrence of interference. If UE 1 transmits an uplink reference signal (e.g., an SRS) through the first and second subframes of every five subframes to cells A, B, and C, the uplink reference signal transmitted through the second subframe may interfere with the uplink reference signal transmitted through the second subframe by UE 4 belonging to cell B. That is, UE 1 having selected cell-specific parameter set 1 transmits an uplink reference signal (e.g., an SRS) through the first subframe of every five subframes to cells A, B, and C in order to decrease the occurrence of interference.

Meanwhile, UE 2 and UE 3 having selected cell-specific parameter set 2 transmit uplink reference signals through the first and second subframes of every five subframes.

Also, from among N cell-specific parameter sets (N=2 in FIG. 8), standards for the determination between a parameter set for general users and a parameter set for users receiving a coordinated multi-point transmission/reception service may be either predefined or transmitted through a signaling.

Further, instead of the cell-specific parameters, UE-specific parameters may be transmitted. In this case, a corresponding BS can transmit specific parameters proper for characteristics of each user. As described above, cell A can determine between general UEs and UEs receiving a coordinated multi-point transmission/reception service and can transmit parameters specified for each UE. Then, the UE receiving a coordinated multi-point transmission/reception service is given a parameter set for itself capable of decreasing interference by a UE of an adjacent cell and can transmit an uplink reference signal by using the given parameter set. Further, the general UE is given a parameter set for itself capable of maximizing its own performance regardless of a UE of an adjacent cell and can transmit an uplink reference signal by using the given parameter set.

As described above, frequency, time, or code resources are divided in order to decrease the occurrence of interference between adjacent cells in transmission of an uplink reference signal in a coordinated multi-point transmission/reception system. Further, in order to decrease performance degradation of other UEs, which do not receive a coordinated multi-point transmission/reception service, due to the division described above, BSs or cells determine between UEs, which receive a coordinated multi-point transmission/reception service, and UEs, which do not receive a coordinated multi-point transmission/reception service, and transmit cell-specific information (or UE-specific information) through a broadcast channel or a data channel. At this time, through an indicator or signaling, by which it is possible to identify a user group, a UE can select an appropriate cell-specific parameter set and can transmit an uplink reference signal.

However, aspects of the present invention are not limited thereto such that other embodiments of the present invention described above may be achieved by applying modifications to the conventional uplink reference signal transmission method.

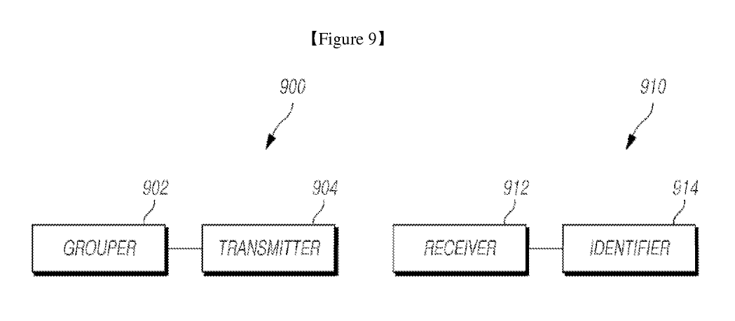

FIG. 9 is a block diagram illustrating a base station and a terminal an uplink reference signal in a mobile communication system according to an exemplary embodiment of the present invention.

For example, a base station (900) to transmit an uplink reference signal in a mobile communication system, may include a grouper (902) to group a plurality of User Equipments (UEs) within a base station into a UE group using a coordinated multi-point transmission/reception service and a UE group using a general service; and a transmitter (904) to transmit parameters established for the UE group using a coordinated multi-point transmission/reception service and the UE group using a general service to the plurality of UEs within the base station.

The transmitter (904) may also transmit an indicator for determining between the UE group using a coordinated multi-point transmission/reception service and the UE group using a general service to the plurality of UEs within the base station.

For another example, a terminal (910) to transmit an uplink reference signal in a mobile communication system may include a receiver (912) to receive parameters established for a UE group using a coordinated multi-point transmission/reception service and a UE group using a general service from a serving cell and an identifier (914) to identify the received parameters and to select a UE group by which the uplink reference signal is to be transmitted from the UE group using a coordinated multi-point transmission/reception service and the UE group using a general service based on the parameters.

The receiver (912) may receive an indicator for determining between the UE group using a coordinated multi-point transmission/reception service and the UE group using a general service and to select the UE group by which the uplink reference signal is to be transmitted from the UE group using a coordinated multi-point transmission/reception service and the UE group using a general service.

Further, for another example, a mobile communication system to transmit and receive a signal in a coordinated multi-point transmission/reception system may include a base station to transmit N parameter sets related to an uplink reference and a terminal to receive the parameter sets and to select a parameter set corresponding to the terminal from among the parameter sets.

The N parameter sets may include two parameter sets, a first one of the two parameter sets corresponds to the terminal for which a coordinated multi-point transmission/reception service is supported, and a second one of the two parameter sets corresponds to the terminal for which a coordinated multi-point transmission/reception service is not supported.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. A method for transmitting an uplink reference signal in a mobile communication system, the method comprising:
grouping a plurality of User Equipments (UEs) within a serving cell into a UE group that uses a coordinated multi-point transmission/reception service and a UE group that uses a general service; and
transmitting first parameters established for the UE group that uses a coordinated multi-point transmission/reception service and transmitting second parameters established for the UE group that uses a general service to the plurality of UEs within the serving cell.

2. The method of claim 1, wherein the first parameters and the second parameters are broadcast through a broadcast channel or are transmitted through a data channel to the plurality of UEs within the serving cell.

3. The method of claim 1, further comprising:
transmitting an indicator for determining between the UE group that uses a coordinated multi-point transmission/reception service and the UE group that uses a general service to the plurality of UEs within the serving cell.

4. The method of claim 1, further comprising
grouping the UEs into the UE group that uses a coordinated multi-point transmission/reception service and the UE group that uses a general service by exchanging information with a cell that is adjacent to the serving cell by the serving cell.

5. The method of claim 1, wherein the serving cell transmits the first parameters and the second parameters.

6. The method of claim 1, wherein the UEs of the UE group that uses a coordinated multi-point transmission/reception service transmit uplink reference signals of at least one type of different resources from among the time, frequency, and code resources from the UEs of the UE group that uses a general service within the serving cell.

7. A method for transmitting an uplink reference signal by a User Equipment (UE) in a mobile communication system, the method comprising:
receiving first parameters established for a UE group that uses a coordinated multi-point transmission/reception service and second parameters established for a UE group that uses a general service from a serving cell;
identifying the received first parameters and second parameters; and
selecting a UE group by which the uplink reference signal is to be transmitted based on the received first parameters and second parameters.

8. The method of claim 7, further comprising:
receiving the first parameters and the second parameters through a broadcast channel or through a data channel.

9. The method of claim 7, further comprising
receiving an indicator for determining between the UE group that uses a coordinated multi-point transmission/reception service and the UE group that uses a general service.

10. The method of claim 7, wherein the UE receives the first parameters and the second parameters from the serving cell.

11. A method of transmitting and receiving a signal in a coordinated multipoint transmission/reception system, the method comprising:
transmitting N parameter sets related to an uplink reference signal by a Base Station (BS);
receiving the N parameter sets by a User Equipment (UE); and
selecting a parameter set that is allocated to the UE from among the N parameter sets by the UE.

12. The method of claim 11, wherein the BS transmits the N parameter sets through a broadcast channel or through a data channel.

13. The method of claim 11, wherein the N parameter sets comprise two parameter sets, a first one of the two parameter sets being for a UE that is supported for a coordinated multi-point transmission/reception service and a second one of the two parameter sets being for a UE that is not supported for a coordinated multi-point transmission/reception service.

14. The method of claim 11, further comprising:
receiving, by the UE, information that indicates whether the UE is supported for a coordinated multi-point transmission/reception service or is not supported for a coordinated multi-point transmission/reception service.

15. The method of claim 11, wherein the N parameter sets are transmitted through a signaling.

16. A base station to transmit an uplink reference signal in a mobile communication system, the base station comprising:
a grouper to group a plurality of User Equipments (UEs) within a base station into a UE group that uses a coordinated multi-point transmission/reception service and a UE group that uses a general service; and
a transmitter to transmit first parameters established for the UE group that uses a coordinated multi-point transmission/reception service and second parameters established for the UE group that uses a general service to the plurality of UEs within the base station.

17. The base station of claim 16, wherein the transmitter transmits an indicator for determining between the UE group that uses a coordinated multi-point transmission/reception service and the UE group that uses a general service to the plurality of UEs within the base station.

18. A terminal to transmit an uplink reference signal in a mobile communication system, the terminal comprising:
a receiver to receive first parameters established for a UE group that uses a coordinated multi-point transmission/reception service and second parameters established for a UE group that uses a general service; and
an identifier to identify the received first parameters and second parameters and to select a UE group by which the uplink reference signal is to be transmitted based on the received first parameters and second parameters.

19. The terminal of claim 18, wherein the receiver receives an indicator for determining between the UE group that uses a coordinated multi-point transmission/reception service and the UE group that uses a general service.

20. The terminal of claim 18, wherein the receiver receives the first parameters and the second parameters from a serving cell.

21. A mobile communication system to transmit and to receive a signal in a coordinated multi-point transmission/reception system, the system comprising:
a base station to transmit N parameter sets related to an uplink reference; and
a terminal to receive the N parameter sets and to select a parameter set corresponding to the terminal from among the parameter sets.

22. The mobile communication system of claim 21, wherein the N parameter sets comprise two parameter sets, a first one of the two parameter sets corresponding to the terminal for which a coordinated multi-point transmission/reception service is supported, and a second one of the two parameter sets corresponding to the terminal for which a coordinated multi-point transmission/reception service is not supported.
